(19) United States
(12) Patent Application Publication
(10) Pub. No.: US 2015/0321759 A1
(43) Pub. Date: Nov. 12, 2015

(54) ROTARY-WING DRONE OF THE QUADRICOPTER TYPE, PROVIDED WITH REMOVABLE BUMPERS FOR PROTECTING THE PROPELLERS

(71) Applicant: PARROT, Paris (FR)

(72) Inventor: Christine Caubel, Paris (FR)

(21) Appl. No.: 14/696,220

(22) Filed: Apr. 24, 2015

(30) Foreign Application Priority Data
May 6, 2014 (FR) 1454084

(51) Int. Cl. B64C 39/02; B64C 27/00

(52) U.S. Cl. CPC B64C 39/024; B64C 27/006; B64C 2201/024; B64C 2201/108

(57) ABSTRACT

The drone (10) comprises a drone body (12) and a plurality of propulsion units (16) to drive propellers (18). Removable lateral bumpers (22) extend beyond the area of rotation of the propellers, each bumper being connected to the propulsion units on the same side by connection arms (24) each comprising a pair of elastically deformable elongated blades with at their end a clamp of mounting on a barrel (26) of the motor. Under the effect of an external transverse effort exerted in a median region, the two blades may be deformed in the direction of a mutual moving closer towards a mounting/dismounting position producing, by leverage, an opening of the clamp, so as to secure the bumper arm to the propulsion unit, and conversely the mounting/dismounting of the bumper by detachment of the clamp from the barrel, by the only transverse effort exerted on the connection arms.

The invention relates to the rotary-wing drones, such as quadricopters. Such drones comprise a drone body and a plurality of propulsion units, each having a propeller driven by a respective motor. Each propulsion unit is mounted at the end of a respective arm for connection to the drone body. A typical example of such a drone is the AR.Drone 2.0 of Parrot SA, Paris.

It is desirable to protect the propellers from the shocks they could undergo against obstacles during the evolution of the drone, in particular when the latter is used in a relatively confined space, and conversely to protect the individuals and the objects from a contact with these propellers in case where the drone would come and touch them.

The drone is of course provided with means allowing to detect any motor rotation abnormality that would be due to a hindrance to the rotation of the propellers, so as to immediately cut the power supply of the motors to avoid any aggravation of the situation. But in case of slight shocks, this extreme solution may be excessive, even as the drone has only brushed against the obstacle.

For those reasons, the drones are generally provided with a protective fairing mounted at the level of the propellers, and extending in the horizontal plane beyond the area of rotation of these latter. In the case of a quadricopter, in particular in the case of the above-mentioned AR.Drone 2.0, this fairing is in the form of a single-piece crown made of moulded expanded plastic material, surrounding the drone on all sides, with four rings combined together and corresponding to the four areas of rotation of the propellers. The unit is integral with a protective shell for the drone body and may be fully removed, when the user wishes to pilot the drone with no protection, in a risk-free open space.

The US2014/099853 A1 discloses a comparable type of quadricopter, provided with a removable protective fairing.

Still other configurations of protective fairings, removable or not, are described in the DE 20 2013 101 170 U1, CN 102381471 A or EP 1 245 257 A2.

A protection in the form of a moulded fairing is extremely efficient as a bumper. On the other hand, it is not devoid of drawbacks.

Firstly, when the drone is equipped with this protective fairing, the aerodynamic performance thereof are noticeably reduced on account of both to the supplement of mass due to the fairing and to the increased drag that the latter exerts against the fast displacements of the drone, in particular in a horizontal plane. For that reason, the users often chose to operate the drone without its protective fairing, with consequent risks of shocks by the propellers.

Secondly, when it is removed, the fairing is bulky due to its shape with the four rings assembled together and linked to the drone body protective shell. Furthermore, to have at his disposal the two possible protected/not-protected configurations, the user must take with him both a protective fairing, i.e. including the shell with the four rings, and a shell alone intended to be mounted on the drone body in the non-protected configuration.

There hence still exists a need to have a protective means for a rotary-wing drone of the quadricopter type, which is more functional than what have been proposed until now, by meeting all the following requirements:
dismountable character, so that the user can choose to have a drone configuration with/without protection;
mounting/dismounting simplicity of the protection, using no tool;
minimal mass, so as not to burden the performances of the drone when the protection has been mounted thereon, hence limitation to the strict minimum of the mechanical structures and systems, without thereby deteriorating the rigidity and robustness thereof;
minimal size, so as not to hinder the user when the latter does not use the protection but however keeps it within reach;
reduction to a minimum of the additional drag due to the presence of the protection, so as not to brake the moving of the drone in the protected configuration;
minimal effect on the lift of the rotary wing, the surface of the elements located under the propeller having to be the most reduced possible so as not to disturb the aerodynamic behaviour.

The invention has for object a new type of protection for a drone of the quadricopter type allowing to achieve all these goals.

It proposes for that purpose such a drone comprising, in a manner known per se, in particular from the above-mentioned US2014/0099853 A1: a drone body; a plurality of propulsion units mounted remote from the drone body at the end of respective support arms, each propulsion unit comprising a propeller driving motor, with a propulsion unit casing comprising a vertical barrel; and removable means for protecting the propellers.

Characteristically of the invention:
the removable means for protecting the propellers comprise removable lateral bumpers extending, in a horizontal plane, beyond the area of rotation of the propellers, each bumper being connected to the propulsion units located on the same side of the drone by respective connection arms;
each connection arm comprises at its proximal end a clamp of mounting on the propulsion unit barrel;
the mounting clamp comprises an elastically deformable cylindrical tube, slit by a notch formed on the proximal side and extending in the axial direction with edges following parallel generating lines, the inner diameter of the tube of the mounting clamp being lower than the diameter of the propulsion unit barrel; and
the transverse width of the notch, in an elastically deformed mounting/dismounting position of the mounting clamp, is higher than the diameter of the propeller unit barrel, to allow the insertion of the clamp about the barrel, then the clamping thereof by the clamp so as to secure the bumper arm to the propulsion unit, and conversely the dismounting of the bumper by detachment of the clamp from the barrel.

According to various subsidiary advantageous characteristics:
each connection arm comprises a pair elastically deformable elongated of blades or rods, extending remote from each other along a common direction between, on the one hand, the distal end of the connection arm where these blades are connected to the bumper in a region of the latter that is directed towards the drone body, and on the other hand, the proximal end of the connection arm where these blades are connected to the mounting clamp;
the two blades are adapted to be elastically deformed, under the effect of an external transverse effort exerted in a median region of the blades in the direction of a mutual moving closer of the arms, towards said mounting/dismounting position where the mutual moving closer of the blades produces at the proximal end of the blades, by leverage, a stressing of the clamp tube in the direction of the moving apart of the notch edges, then clamping of the clamp about the barrel upon relaxation of the transverse effort exerted on the arms, so as to secure the bumper arm to the propulsion unit, and conversely the mounting/dismounting of the bumper by detachment of the clamp from the barrel, by the only transverse effort exerted on the connection arms;
the cross-section of the blades is rectangular, with the greatest size of this cross-section oriented parallel to the axis of rotation of the propulsion unit propeller;
the connection arm, comprising the pair of blades and the mounting clamp, is a single-piece part made of plastic material;
the cross-section of the cylindrical tube of the clamp has a C shape with two branches extended on either side of a central portion forming an elastic hinge, and in which the blades are connected the respective branches of the C in a median region of the branch; and
the drone is a quadricopter comprising four propulsion units arranged two by two on each side of the drone body, and in which the drone is provided with two removable lateral bumpers arranged symmetrically with respect to the drone body, each bumper being provided with two arms for the connection to the respective propulsion units located on the same side of the drone body.

An exemplary embodiment of the invention will now be described, with reference to the appended drawings where the same references denote identical or functionally similar elements throughout the figures.

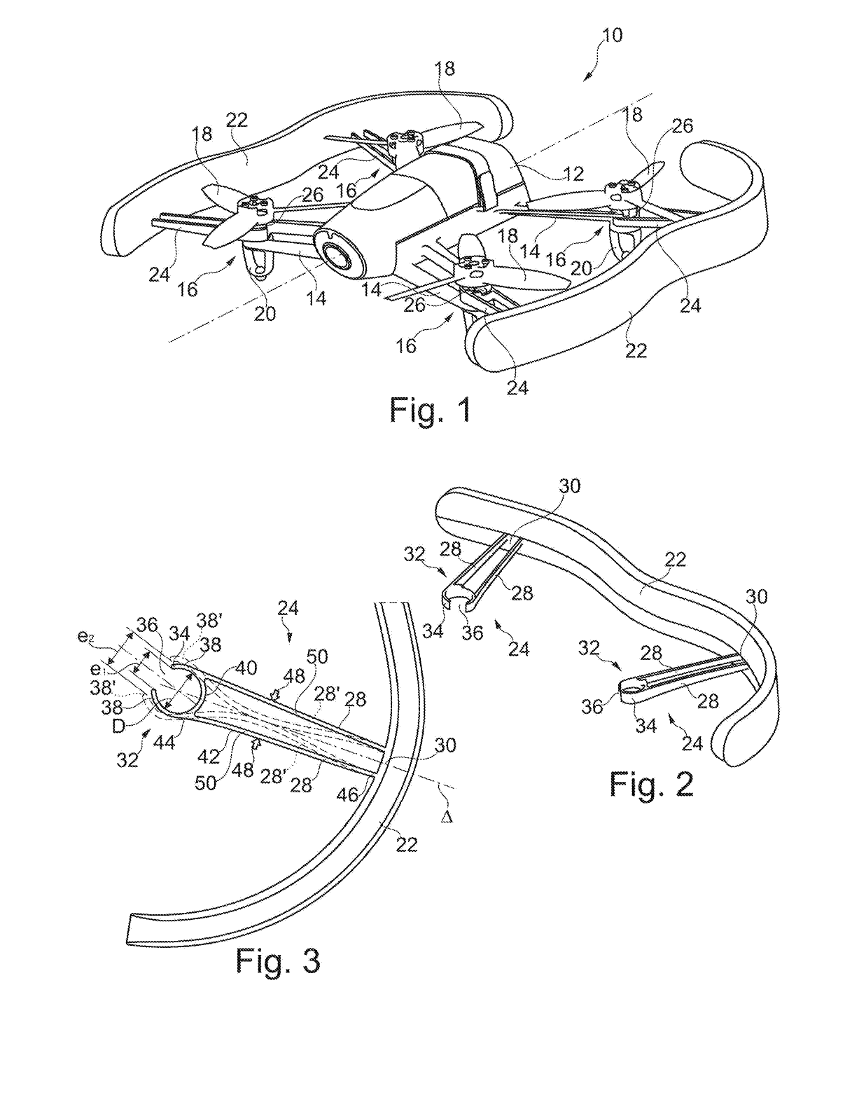

FIG. 1 is a perspective view of a drone provided with its protective bumpers according to the invention;

FIG. 2 is a perspective view of a bumper shown in isolation, showing in particular the means for connection and fixation to the drone.

FIG. 3 is a partial magnified top view of the bumper of the FIG. 2, showing in particular the structure of the connection arm and of the fixation clamp.

In FIG. 1 is shown a drone 10 of the quadricopter type, with a central drone body 10, from which four support arms 14 radiate. Each support arm 14 is equipped at its distal end with a propulsion unit 16 comprising a motor driving into rotation a propeller 18 extending in a horizontal plane above the support arm 14. In the lower part, the propulsion unit 16 is continued by a footing stirrup 20 by which the drone can rest on the ground when stopped.

To ensure the protection of the propellers, the drone is provided with two removable lateral bumpers 22 arranged symmetrically with respect to the drone body 12. The bumpers have an elongated shape and extend, in the horizontal plane, beyond the area of rotation of the propellers 18, hence ensuring a protection mainly with respect to lateral shocks: hence, in case of erratic lateral movement of the drone, the bumper 22 comes in interposition between a potential obstacle and the propellers 18, protecting these latter. The contact of the bumper 22 with the obstacle will also have for effect to cause a lateral bounce of the drone, tending to space the latter apart from the obstacle.

The front extent of the bumper 22 is limited so as not to appear in the field of view of the front camera of the drone, which is a wide-angle camera; on the rear, the bumper 22 may extend with a slightly rounded portion covering a portion of the rear propeller and hence protecting the latter in case of moving rearward of the drone.

Each of the two bumpers 22 is connected to the two propulsion units 16 located on the same side, through a corresponding pair of connection arms 24 whose proximal end (the closest from the drone body 12) fits on a cooperating portion 26 of the propulsion unit 16, for example a vertical cylindrical barrel of the casing of this propulsion unit 16.

FIG. 2 illustrates in more detail the structure of one of the bumpers 22 (the other being symmetrical), and in particular of the connection arms 24 and of their means of mounting on the propulsion unit barrel.

Each of the connection arms 24 is advantageously consisted of two substantially parallel blades or rods 28 extending between, on the one hand, a distal end 30 where they are connected to the bumper itself in a region of the latter that is directed towards the drone body, and a proximal end provided with a means 32 forming a clamp of mounting on the propulsion unit barrel. This mounting clamp comprises a cylindrical tube 34 slit by a notch 36 on the proximal side (the side directed towards the propulsion unit), this notch being formed with edges corresponding to parallel vertical generating lines of the tube 34.

The blades 28 are advantageously of rectangular cross-section, with their greatest size oriented vertically, i.e. parallel to the propeller axis, so that the presence of these blades, that come under the propeller 18 when the bumper is mounted on the drone, disturb the less possible the aerodynamic behaviour of the propellers and hence introduce only a negligible loss of lift.

The bumper 22 itself is for example made of expanded polypropylene, allowing to make a part with a relatively high volume but low mass, and the connection arm 24 is a single-piece part made of an elastically deformable plastic material, for example ABS, the unit formed by the blades 28 and the cylindrical tube 34 of the mounting clamp 32 being a moulded single-piece element.

FIG. 3 illustrates more precisely, in top view, the structure of the connection arm and the way to handle the mounting clamp 32 by clamping of the blades 28.

The mounting clamp 32 has, in top view, a C-shaped section with an inner diameter D slightly lower than the diameter of the cylindrical barrel 26 of the propulsion unit on which the clamp 32 will be placed. The C-shaped section comprises two branches 38 extending from a central portion 40 forming an elastic hinge. To allow the deformation of the clamp 32, the branches 38 are connected to the proximal end 42 of the respective blade 28 in a median region 44 of the branch 38. The opposite, distal end 46 of each of the blades 28 is connected to the bumper 22 with which they constitute, mechanically, a single-piece unit.

The handling of the mounting clamp 32 is performed as follows.

To open the clamp, the user exerts an external transverse effort 48 on each of the median regions 50 of the blades 28 in the direction of a mutual moving closer towards their common axis A. Due to the elastically deformable nature of the material constituting the blades 28, these latter are deformed, as illustrated in dashed line in 28′, which has for consequence, by leverage exerted on the median region 44 of the branches 38, to deform these latter as illustrated in dashed line in 38′, with for consequence an increase, from e₁ to e₂, of the spacing between the free ends of these branches 38. The whole is designed so that, for a full clamping of the blades 28 (i.e. when these latter come into contact with each other on their inner faces), the spacing e₂ between the free ends of the branches 38 is higher than the diameter of the barrel 26 of propulsion unit, hence allowing to assemble or disassemble with no difficulty the mounting clamp 32 and to secure each of the connection arms 24 with the propulsion unit 16, using no tool. After positioning of the clamp 32 about the barrel 26 of the propulsion unit 16, the disengagement of the two blades 28 will have for effect to move closer to each other the branches 38, which will clamp the barrel 26 without clearance, due to the diameter D slightly lower than the outer diameter of the barrel.

1. A rotary-wing drone of the quadricopter type (10), including:
a drone body (12);
a plurality of propulsion units (16) mounted remote from the drone body at the end of respective support arms (14), each propulsion unit comprising a motor for driving a propeller (18), with a propeller unit casing comprising a vertical barrel (26); and
removable means for protecting the propellers,
characterized in that:
the removable means for protecting the propellers comprise removable lateral bumpers (22) extending, in a horizontal plane, beyond the area of rotation of the propellers, each bumper being connected to the propulsion units located on the same side of the drone by respective connection arms (24);
each connection arm comprises at its proximal end (42) a clamp (32) of mounting on the propulsion unit barrel;
the mounting clamp (32) comprises an elastically deformable cylindrical tube (34), slit by a notch (36) formed on the proximal side and extending in the axial direction with edges following parallel generating lines, the inner diameter (D) of the tube of the mounting clamp being lower than the diameter of the propulsion unit barrel; and
the transverse width (e₂) of the notch (36), in an elastically deformed mounting/dismounting position of the mounting clamp (32), is higher than the diameter of the propeller unit barrel, to allow the insertion of the clamp about the barrel, then the clamping thereof by the clamp so as to secure the bumper arm to the propulsion unit, and conversely the dismounting of the bumper by detachment of the clamp from the barrel.

2. The drone according to claim 1, wherein:
each connection arm comprises a pair of elastically deformable blades (28) or rods, extending remote from each other along a common direction (Δ) between, on the one hand, the distal end (46) of the connection arm where these blades (28) are connected to the bumper in a region (30) of the latter that is directed towards the drone body, and on the other hand, the proximal end (42) of the connection arm where these blades (28) are connected to the mounting clamp (32); and
the two blades are adapted to be elastically deformed, under the effect of an external transverse effort (48) exerted in a median region (50) of the blades in the direction of a mutual moving closer of the arms, towards said mounting/dismounting position where the mutual moving closer of the blades (28′) produces at the proximal end of the blades, by leverage, a stressing of the clamp tube in the direction of the moving apart of the edges of the notch (36), then clamping of the clamp about the barrel upon relaxation of the transverse effort exerted on the arms, so as to secure the bumper arm to the propulsion unit, and conversely the mounting/dismounting of the bumper by detachment of the clamp from the barrel, by the only transverse effort exerted on the connection arms.

3. The drone of claim 2, wherein the cross-section of the blades (28) is rectangular, with the greatest size of this cross-section oriented parallel to the axis of rotation of the propulsion unit propeller.

4. The drone of claim 2, wherein the connection arm, comprising the pair of blades (28) and the mounting clamp (32), is a single-piece part made of plastic material.

5. The drone of claim 2, wherein the cross-section of the cylindrical tube of the clamp has a C shape with two branches (38) extended on either side of a central portion (40) forming an elastic hinge, and wherein the blades are connected the respective branches of the C in a median region (44) of the branch.

6. The drone of claim 1, wherein the drone is a quadricopter comprising four propulsion units (16) arranged two by two on each side of the drone body (12), and wherein the drone is provided with two removable lateral bumpers (22) arranged symmetrically with respect to the drone body, each bumper being provided with two arms (24) for the connection to the respective propulsion units (16) located on the same side of the drone body.
